(19) United States
(12) Patent Application Publication
(10) Pub. No.: US 2016/0174343 A1
(43) Pub. Date: Jun. 16, 2016

(54) LED Retrofit Assembly

(71) Applicant: Production Resource Group, LLC, New Windsor, NY (US)

(72) Inventors: Robert Kliegl, Putnam Valley, NH (US); Bruce McFarlane, Wallkill, NY (US); Gary Leonard, Wappingers Fall, NY (US); Russell Mahaffey, Highland Village, TX (US); Daniel Hooper, Dallas, TX (US); Thomas A. Hough, Dallas, TX (US); Ted Samuelson, Flower Mound, TX (US); Christopher Conti, Rutherford, NJ (US)

(21) Appl. No.: 14/944,866

(22) Filed: Nov. 18, 2015

Related U.S. Application Data
(60) Provisional application No. 62/081,638, filed on Nov. 19, 2014.

(51) Int. Cl. H05B 37/02; H05B 33/08; F21K 99/00

(52) U.S. Cl. CPC H05B 37/0272; F21K 9/50; H05B 33/0845; F21Y 2101/02

(57) ABSTRACT

A retrofit kit for an existing lamp uses its lighting and optical structure to retrofit existing lamp and use the existing lens of the lamp. The new lamp also includes electronic controls which enable remotely or manually controlling the lamp, and also enable other functions.

This application claims priority from provisional application NO. 62/081,638, filed Nov. 19, 2014, the entire contents of which are herewith incorporated by reference.

### BACKGROUND

Incandescent light sources of many types have been known. LEDs can be used to retrofit incandescent fixtures, to obtain better illumination efficiency and less heat. In some lighting fixtures, an LED can simply be inserted into the light fixture in place of the existing light source, e.g., a retrofit bulb. However, in other lighting fixtures, a more complete retrofit may be necessary, in order to address the way that the LED outputs light, and other issues, including the necessity to keep the LEDs cooled.

Our U.S. Pat. No. 8,721,134 describes a retrofit kit for a lamp that uses tungsten light bulbs, and which retrofits that lamp to use LEDs as its light source.

### SUMMARY

There are many different kinds of lighting devices that use tungsten lamps. An embodiment describes an LED retrofit assembly for an existing ellipsoidal spotlight known as the Source Four, manufactured by Electronic Theatre Controls. However, the techniques used as described herein can be used with other lighting devices and to retrofit other fixtures.

### BRIEF DESCRIPTION OF THE DRAWINGS

in the drawings:

FIG. 1 shows a diagram retrofitting an existing lamp with an LED fixture according to the present application;

FIG. 2 illustrates about the retrofit assembly and its control;

FIG. 3 shows the control assembly of the retrofit assembly;

FIG. 4 shows the optical configuration of the retrofit assembly;

FIG. 5 shows the system layout showing the source rays when used according to the present application.

### DETAILED DESCRIPTION

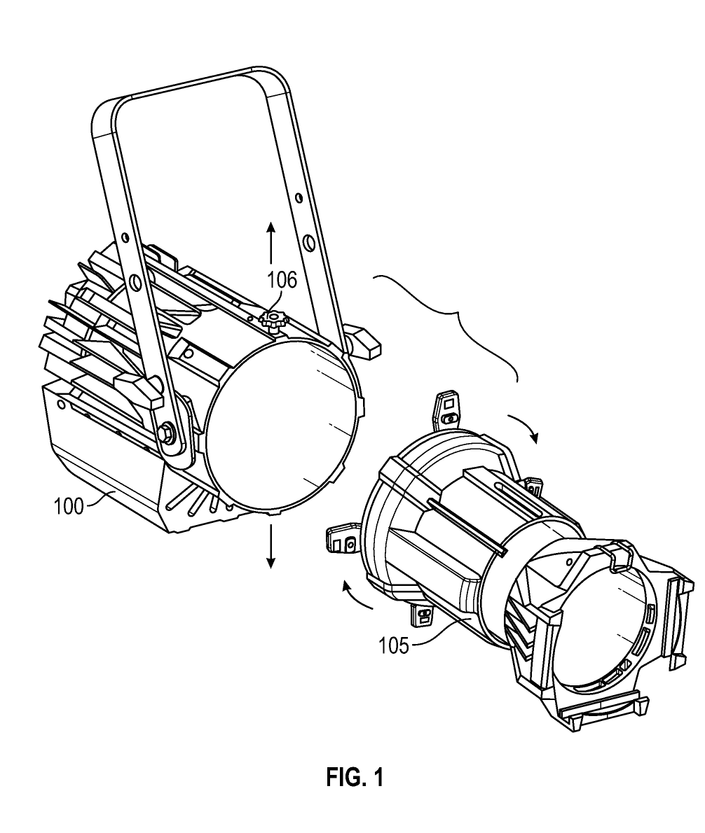

In an embodiment, a new LED light engine replaces the incandescent light source of an original fixture, in the embodiment, a Source Four ellipsoidal luminaire. The lens assembly of the original source Four is attached to the retrofit housing. As shown in the FIG. 1, the retrofit housing includes a screw 106 which is tightened to press against an outer edge of the source for lens 105. This allows reusing the source for lens 105 with the new optical assembly 100. As explained herein, the new optical assembly also has its own optical structure therein, which is optimized for use with the ellipsoidal lens assembly of the source Four. As explained herein, this can be used with other luminaires, but the source Four is an embodiment, and is shown in FIG. 1.

In the embodiment of FIG. 1, the Renew assembly 100 is attached to an existing source Four ellipsoidal lens assembly 105. The renew assembly is intended to replace the rear lamp assembly of the source Four, using the existing lens of the source Four.

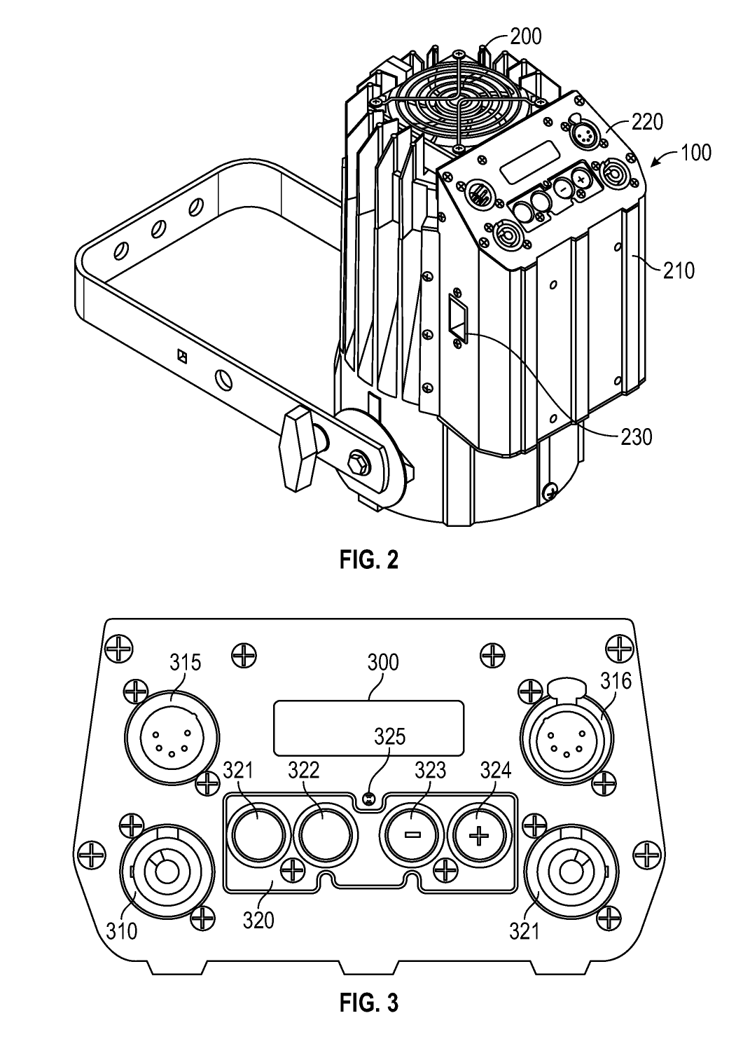

FIG. 2 shows more details about the embodiment. The renew assembly 100 includes a head assembly 200 that holds the LED light, and the driver box 210 which includes the interface panel and control assembly. This embodiment replaces the rear casting assembly and lamp housing of the existing lamp. The retrofit engine can attach to the Source Four optical assembly via the same twist-mount, Phillips head screw, and tool-free knob as the original manufacturer's rear assembly.

Once the renew is joined together with the front-end optical train of the Source Four, it can be operated with a new energy efficient LED assembly that operates at 130-watts and a lifetime rating of 50,000 hours.

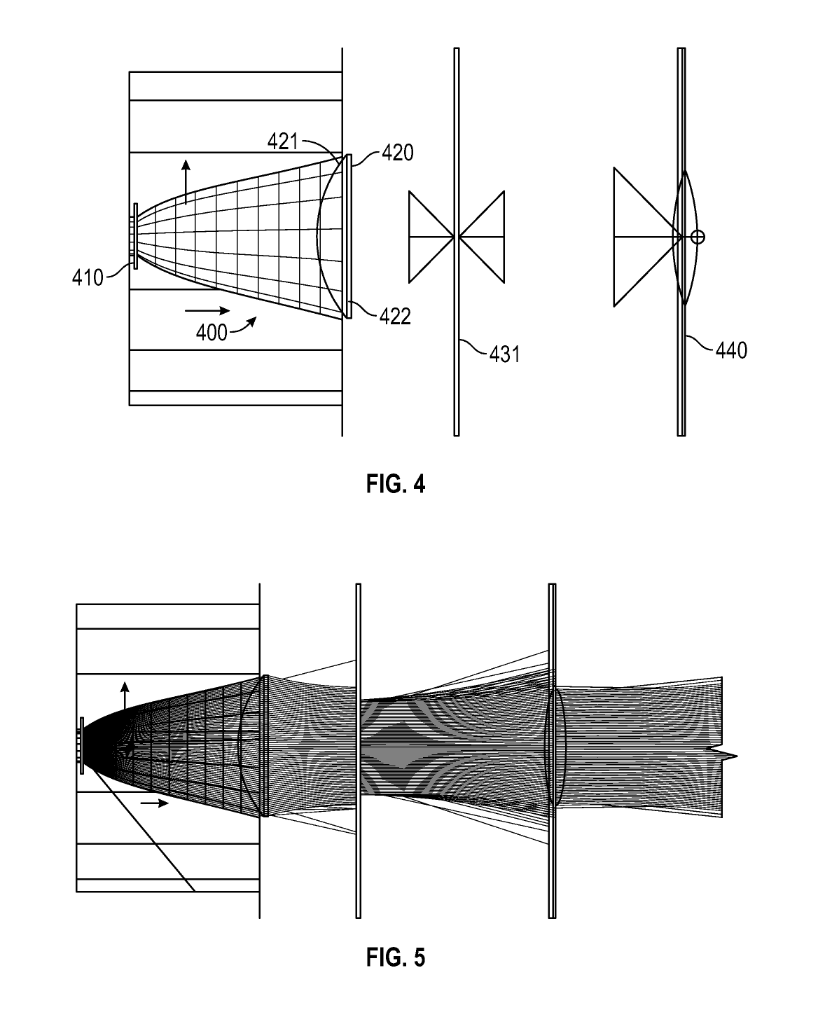

The retrofit assembly can have any of a number of different kinds of LED light sources on board. For example, the retrofit assembly can have a single high output LED array (using chip on board or “COB” technology as shown as 400 in FIG. 4) in a choice of, for example, either 3,000K Tungsten or 5,000K Daylight color temperatures. Control is via DMX 512-A or user selectable stand-alone options. A DMX control signal can be connected to and passed thru the ReNew via a male connector shown as 315 in FIG. 3, and/or a female flush mount 5-Pin XLR connector shown as 316 in FIG. 3. The DMX connections are optically isolated.

The Renew has different user selectable personality settings for adjusting how the fixture responds to DMX control commands. These settings allow for various settings. One of the settings can set whether 8-bit or 16-bit control is used via one or multiple DMX channels, or whether 24-bit is used.

One embodiment recognizes that the way that LEDs react to dimming is very different than the way that analog bulbs, such as incandescent bulbs, reacted to dimming. According to an embodiment, there are different dimming settings that can be loaded as a dimming curve. In one embodiment, the dimming curve of the ReNew is user adjustable between a linear setting, which tries to match to the way that an LED dims, and a tungsten setting that matches to the way that a tungsten bulb dims. These dimming curves can be refined further with selectable Coarse, Fine and Medium adjustments which change the response of the ReNew to the commands of a DMX signal. In this way, the DMX signal can command the renew to dim in the same way that a tungsten bulb such as in the original fixture would have dimmed. As an example, when in the “tungsten dim” or “incandescent dim” mode, dimming to 50% will cause the LED light to dim to what a tungsten would have dimmed to at 50%. In contrast, dimming to 50% while in normal or LED temp mode simply provides 50% power to the LED and dims it to the way the LED looks after a 50% dim cycle.

There is also a menu system, which enables the characteristics of the lamp to be configured from the menu itself. The menu system can be used for any of the functions described herein, including manual intensity level settings, fade and strobe effects as well as a Focus setting. Changing the settings to the ReNew is done via a multi-button command station with display screen which shows all information in the various menus.

The LED light engine is set inside a housing that has a user adjustable front end (barrel) which holds a plastic or glass Fresnel lens as described herein. The adjustments are made manually without the use of tools by the user. The Fresnel lens when set closer to the LED array collects the light from the engine's initial distribution and disperses light to form a wide and uniform beam of light. When the Fresnel lens is adjusted at the furthest point from the LED engine, the light is collected to achieve a tight uniform beam.

The Fresnel lens can optionally be used, and may be also used in conjunction with a secondary diffuser lens or holographic lens to further blend the beams of light as required as to not image the LED engine's structure.

As shown in FIG. 2, the head 200 houses the light engine/array and the lens or lenses for creating the desired beams. The power and/or control assembly is referred to as the Driver box 210. In the embodiment shown in FIG. 2, the driver box is attached to a surface of the head, which is a surface of the head which does not have heatsinks thereon. As an alternative, however, the driver box can be separated from the head and be remotely mounted from each other.

The head assembly is designed to allow the user to attach optional accessories such as linear spread lenses to create adjustable linear beam angles as opposed to the standard round beam shapes. Another accessory is an ellipsoidal zoom focus (20-50 D) lens system for precise focusing of the Bullet Series™ narrow beam. The lens system allows for using the focused beam sizes alone or with optional steel, glass or 35 MM film slides for projecting images, text or textures.

Glass (Dichroic/Devon Glass) of plastic (gel) colored diffusions can also be used for tinting the beam of light to user defined colors.

Other possible accessories include 4 leaf barndoors for soft cropping of the bean and a cylindrical hood or snoot for blacking light from the sides and reducing visibility while in use in architectural, theatrical or theme park applications.

In operation, the user can control the operation of the system via the interface panel 220 which is shown as the rear end of the driver box in FIG. 2. FIG. 3 shows additional details of this interface panel. The interface panel shows on the menu display 300 the current DMX address. The connector also includes AC inputs 310 and output 311 to allow daisy chaining, as well as a DMX input 315 and output 316. The editing buttons 320 are used to control the operation of the lamp.

A comm indicator 325 provides feedback during the operation in one embodiment, the comm indicator is a green LED, located at the luminaire's interface panel, provides feedback during operation as follows:

+Solid—Valid DMX received.

+Slow Blink—DMX is expected but not received.

+Fast Blink—An internal error has occurred.

+No Light—No DMX expected, no DMX received (manual modes only).

The luminaire is initially powered up by turning on the breaker, since the luminaire has no power on-off switch in one embodiment. By powering up, the luminaire defaults to the last mode that was set.

The initial mode defaults to Navigation. In this mode, left (<) and right (>) arrows are displayed around the current menu title, such as “<DMX Address >” as it is shown in FIG. 3. When the left and right arrows are displayed like this, pressing the minus [−] or plus [+] buttons moves to the next or previous menu item.

The user can exit the navigation mode, by pressing the [Menu/Cancel] button 321 to return to the Mode menu. The mode menu displays up and down arrows, to signify that the user can press the minus and plus buttons in order to move through the different modes.

Pressing the [Edit/Set] button 322 switches the interface to Edit mode. In this mode, plus (+) and minus (−) symbols are displayed to the left and right of an editable value that is displayed on the menu display 300, such as “−1+”. In this mode, the user can press the minus and plus keys in order to increment and decrement the editable value.

+Pressing the [Edit/Set] button 322 again sets the displayed value and returns to the Navigation mode.

+Pressing the [menu/Cancel] button while in Edit mode restores the original value before editing began and returns to the Navigation mode.

When in mode select, one of the modes is the focus mode. The focus mode can be used, for example, to turn on the lamp momentarily for the purpose of aiming and focusing the light. As an alternative to selecting the focus mode using the mode signals, there is also a hot key, focus mode can be entered from anywhere in the menu by pressing [Edit/Set] and minus [−] buttons together. In the focus mode, the fixture outputs 100% intensity for five minutes. Time can be added or removed from the timer with the plus [+] and minus [−] keys 323 and 324.

The panel can also be used for changing the DMX address, setting the fixture for 16-bit intensity control, and, as described above, changing the dimming curve and/or response time.

When the fixture is first powered on, it begins at the DMX Address screen where the user can set the DMX address by pressing [Edit/Set] 322, putting the fixture in a mode where it will accept editing of the DMX address. The editing is indicated by the <and >which indicate that the DMX address can be edited up-and-down. The user can then use the [+] and [−] buttons to set the desired DMX address, then press [Edit/Set] 322 again to save the value that was entered.

There are also other DMX controls which can be used. The DMX Mode sets the fixture's DMX footprint or personality. This provides a trade-off between control and the amount of space occupied on the DMX universe. For example, the user can select one channel 8 bit intensity control, to take up only one channel on the DMX universe like a conventional dimmer. However, if the user desires more control over this, the user can instead select to channel 16 bit intensity control for finer control and smoother operation. Another possible alternative can select 3 channel 16 bit intensity control with FX, which provides 16 bits of intensity control and an 8 bit macro channel. The 8 bit macro channel provides additional settings for automated strobe and fade settings.

DMX Fault Defines the fixture's output state upon loss of DMX signal. There are different possibilities including Last Look which maintains the last DMX command received until a valid DMX is restored. 0% Intensity mode since the fixture intensity down to 0% upon loss of DMX. Conversely, 100% intensity mode since the fixture intensity to 100% intensity on loss of DMX.

DMX Dim Curve Adjusts the dimmer curve between different profiles. A tungsten power-law response, causes the LED to dim using a profile and dimming speed that is similar to a tungsten fixture. A linear response just causes a linear dimming, without the tungsten dimming profile.

DMX Smoothing is used to apply a smoothing filter to the DMX input, adding some delay to make the output response appear more “natural.” When DMX smoothing is off, there is no filter, and the fixture responds instantly to commands.

Different kinds of filtering profiles can also be used. Moderate filtering, reduces flicker induced by step changes to DMX input.

Tungsten heavy filtering, produces an output that resembles the response of a tungsten fixture.

The DMX Address can be changed by using the up and down keys.

If the fixture is in a different mode than what is desired, it can be changed by pressing the [Mode/Cancel] button (multiple times if necessary) until the Mode menu appears: The user selects the desired mode from the list by pressing the [+] and [−] buttons. Once the correct mode is shown, press [Edit/Set] to enter that mode.

+DMX Control—Sets the luminaire to be controlled by DMX512. (This is the default mode.)

+Manual Intensity—Sets the luminaire's brightness level manually, Once in Manual Intensity mode, the display will show the intensity setting. Use the [Edit/Set] button to enter editing mode, and the plus [+] and minus [−] buttons to adjust the output level:

+Manual Effects—Configures effects such as pulse, fade, and strobe. There are three types of fade effects, as well as a strobe and a random strobe. Adjustable settings include the effect type, effect rate, and effect maximum intensity.

+Pulse On—Sawtooth waveform.

+Pulse Off—Sawtooth waveform.

+Fade—Triangle waveform.

+Fast Strobe—Strobe effect.

+Random—Random strobing effect

+Utilities—Used to access special functions and luminaire information.

The Illumination system in the LED device uses a special lensing system to allow improved lighting output. The existing ETC source 4 ellipsoidal reflector spotlight (ERS) employs a releasably attached lamp house comprising a tungsten halogen lamp and a molded glass reflector, such as described in U.S. Pat No. 5,544,029. The body of the Source 4 ERS comprises a gate (shown as 430 in FIG. 4), a shutter assembly, and a series of interchangeable lens tubes shown as 440. The new lamp housing comprises a chip on board (COB) led light source array 410, a reflector 400, and a lens 420. The lens and reflector provide the desired illuminance distribution at the Source 4 ERS projection gate 430 and maximizes the amount of light projected through the Source 4 ERS projection lens system(s).

The optical system for the renew fixture is shown in FIG. 4. The reflector 400 is a faceted free form reflector that is a long a free form curve. Lens 420 is a collection lens with an aspheric input circuit surface 421 and a planar output surface 422. This produces flux which is sent to the gate 430 and projection lens 440 of the existing source 4 projector.

The system layout showing source rays is shown in FIG. 5 at different locations corresponding to the optical structures in FIG. 4.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, other lenses and other effects can be used.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. Likewise, external bus 18 may be any of but not limited to hard wired external busses such as IEEE-1394 or USB. The computer system can also have a user interface port that communicates with a user interface, and which receives commands entered by a user, and a video output that produces its output via any kind of video output format, e.g., VGA, DVI, HDMI, displayport, or any other form. This may include laptop or desktop computers, and may also include portable computers, including cell phones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A retrofit assembly for an existing luminaire, comprising:
A housing, having an LED lighting device, and having a reflector, optical gate, and optical lens, said LED lighting device, reflector, optical gate and optical lens all being set for use with an existing lens of the existing luminaire that is being retrofitted, such that light rays output from the LED, reflector, optical gate and optical lens are further focused by the existing lens,
where the housing also includes an electronic automation control that responds to remotely sent electronic commands and a user interface that enables changing parameters of the response to the remotely sent electronic commands.

2. The system as in claim 1, wherein the user interface enables changing how many channels of control are accepted by the retrofit assembly, between one channel of control and multiple channels of control.

3. The system as in claim 1, wherein the user interface accepts commands for changing the profile between a first linear dimming profile and a second simulation profile which simulates the dimming profile of the existing luminaire which has a different type of lighting element.

4. The system as in claim one, wherein the reflector is a faceted free form reflector, and the optical lens is a projection lens.

5. The system as in claim 1, wherein the remotely sent electronic commands are in DMX format.

6. The system as in claim 5, and further comprising a DMX indicator, which is a single lamp, and whose on-off condition indicates all of whether a valid DMX command has been received, whether a valid DMX command is expected but not received, whether an error has occurred, and also whether the system is in DMX manual mode and no DMX is expected or received.

7. The system as in claim 5, wherein the user interface enables changing the profile for fixture output state upon loss of DMX and until valid DMX received, between at least 0% intensity mode which sets the fixture intensity to 0% upon loss of DMX and 100% intensity mode which sets the fixture intensity to 100% intensity on loss of DMX.

8. The system as in claim 1, wherein the user interface enables changing to a focusing mode where the fixture outputs 100% intensity for a specified amount of time.

9. The system as in claim 1, wherein the user interface accepts commands which change a number of bits accepted by the electronic automation control, and uses a different number of bits for the control based on the change.

10. A retrofit assembly for an existing luminaire, comprising:
A housing, having an LED lighting device, and having a reflector, optical gate, and optical lens, and an electronic automation control that responds to remotely sent electronic commands and a has a user interface that enables changing parameters of the response to the remotely sent electronic commands, wherein the user interface accepts changes between manual operation where the lighting functions are set on the user interface, and automatic operation, where the lighting functions are received over an electronic control, wherein the user interface also accepts controls which the way the LED device reacts to commands.

11. The system as in claim 10, wherein the user interface enables changing how many channels of control are accepted by the retrofit assembly, between one channel of control and multiple channels of control.

12. The system as in claim 10, wherein the user interface accepts commands for changing the profile between a first linear dimming profile and a second simulation profile which simulates the dimming profile of the existing luminaire which has a different type of lighting element than the LED lighting device.

13. The system as in claim 10, wherein the reflector is a faceted free form reflector, and the optical lens is a projection lens.

14. The system as in claim 10, wherein, in the automatic operation, the commands received are in DMX format.

15. The system as in claim 14, and further comprising a DMX indicator, which is a single lamp, and whose on-off condition indicates all of whether a valid DMX command has been received, whether a valid DMX command is expected but not received, whether an error has occurred, and also whether the system is in DMX manual mode and no DMX is expected or received.

16. The system as in claim 14, wherein the user interface enables changing the profile for fixture output state upon loss of DMX and until valid DMX received, between at least 0% intensity mode which sets the fixture intensity to 0% upon loss of DMX and 100% intensity mode which sets the fixture intensity to 100% intensity on loss of DMX.

17. The system as in claim 15, wherein the user interface enables changing to a focusing mode where the fixture outputs 100% intensity for a specified amount of time.

18. A method of retrofitting an existing incandescent luminaire which has a lighting portion and the lens portion, said method, comprising:
replacing the lighting portion with a retrofit housing having an LED lighting device, and having a reflector, optical gate, and optical lens, said LED lighting device, reflector, optical gate and optical lens all being set for use with an existing lens of the existing luminaire that is being retrofitted;
operating the lighting portion such that light rays output from the LED, reflector, optical gate and optical lens are further focused by the lens portion of the existing incandescent luminaire,
operating the luminaire using an electronic automation control that responds to remotely sent electronic commands and a user interface that enables changing parameters of the response to the remotely sent electronic commands.

19. The method as in claim 18, further comprising using the user interface for changing how many channels of control are accepted by the retrofit assembly, between one channel of control and multiple channels of control.

20. The method as in claim 18, further comprising the user interface for accepting commands for changing the profile between a first linear dimming profile intended for linearly dimming an LED lamp, and a second simulation profile which simulates the dimming profile of the incandescent bulb in the existing luminaire.

21. The method of claim 18, wherein the remotely sent electronic commands are in DMX format.

22. The method as in claim 21, further comprising using a single lamp as a DMX indicator, by operating the single lamp for its on-off condition to indicate all of whether a valid DMX command has been received, whether a valid DMX command is expected but not received, whether an error has occurred, and also whether the system is in DMX manual mode and no DMX is expected or received.

23. The method as in claim 21 further comprising using the user interface to change the profile of operation of the between a first fixture output state upon loss of DMX and until valid DMX received, between at least 0% intensity mode which sets the fixture intensity to 0% upon loss of DMX and 100% intensity mode which sets the fixture intensity to 100% intensity on loss of DMX.

24. The method as in claim 18, wherein the user interface enables changing to a focusing mode where the fixture outputs 100% intensity for a specified amount of time.
